(19) United States
(12) Patent Application Publication
(10) Pub. No.: US 2018/0187847 A1
(43) Pub. Date: Jul. 5, 2018

(54) IMPROVED COORDINATED EFFECTS SYSTEM FOR AN AUTOMATED LUMINAIRE

(71) Applicant: Robe Lighting s.r.o., Rosnov pod Radhostem (CZ)

(72) Inventors: Pavel JURIK, Prostredni Becva (CZ); Josef VALCHAR, Prostredni Becva (CZ)

(73) Assignee: Robe Lighting s.r.o., Roznov pod Radhostem (CZ)

(21) Appl. No.: 15/516,399

(22) PCT Filed: Oct. 1, 2015
(86) PCT No.: PCT/US15/53566

§ 371 Date: Apr. 1, 2017

Related U.S. Application Data
(60) Provisional application No. 62/058,562, filed on Oct. 1, 2014.

(51) Int. Cl. F21S 10/00; F21V 14/06; F21V 5/02

(52) U.S. Cl. CPC F21S 10/007; F21W 2131/406; F21V 5/02; F21V 14/06

(57) ABSTRACT

Described is dynamic and coordinated control of the insertion and positioning of multiple prism effects systems installed in an automated luminaire. Positioning sensors allow the precise control of the relative orientation of two or more prism rotation systems.

### RELATED APPLICATION

The present application claims priority to provisional application 62/058,562 filed 1 Oct. 2014.

### TECHNICAL FIELD OF THE INVENTION

The present invention generally relates to an effects system in a luminaire, and more specifically to a system for coordinating multiple effects within an automated luminaire.

### BACKGROUND

Luminaires with automated and remotely controllable functionality are well known in the entertainment and architectural lighting markets. Such products are commonly used in theatres, television studios, concerts, theme parks, night clubs and other venues. A typical product will commonly provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. FIG. 1 illustrates a typical multiparameter automated luminaire system 10. These systems typically include a plurality of multiparameter automated luminaires 12 which typically each contain on-board a light source (not shown), light modulation devices, electric motors coupled to mechanical drives systems and control electronics (not shown). In addition to being connected to mains power either directly or through a power distribution system (not shown), each luminaire is connected is series or in parallel to data link 14 to one or more control desks 15. An operator typically controls the luminaire system 10 through the control desk 15.

An optical effect that is commonly used in prior art automated luminaires is often referred to as a prism. This is typically a glass or plastic device placed at a point in the optical train such that it converts a single image produced by the beam color, size, shape, and pattern optical systems into multiple beams for display. For example, a linear prism may convert a single beam into a linear array of identical beams. A diagrammatic example of the effects produced by a prior art prism optical system is shown in FIGS. 2 and 3. In FIG. 2, single image 20 produced by the beam color, size, shape, and pattern optical systems passes through prism 21a resulting in multiple copies of image 20 as images 22a. Prism 21a may be rotated 23 causing a similar rotation 24 in the array of output images. FIG. 3 shows the same optical system and prism, but with prism 21b rotated to a new position 21b resulting in a corresponding rotation of the output images 22b. Image 20 is here shown for clarity as a simple circular image, however in reality image 20 may be any complex image as produced by the automated luminaire, in particular it may have a shape defined by the patterns or gobos in the optical train.

In further prior art systems the prism may be different shapes and may be capable of being inserted or removed from the light beam automatically. It may further be possible to select different prisms producing different effects for insertion in the beam. However, the prior art systems are only capable of introducing a single prism at one time.

It would be advantageous to provide a system for an automated luminaire that was capable of introducing a plurality of prisms into the optical effect chain simultaneously such that the effects concatenate. It would further be advantageous to be able to selectively and cooperatively coordinate the insertion, position, and rotation of the plurality of prisms to produce new dynamic lighting effects.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical prior art automated lighting system;

FIG. 2 illustrates a prior art prism effects system;

FIG. 3 illustrates a prior art prism effect system;

FIG. 4 illustrates an embodiment of the invention with all prisms removed from the light beam;

FIG. 5 illustrates an embodiment of the invention with first prism inserted in the light beam;

FIG. 6 illustrates an embodiment of the invention with second prism inserted in the light beam;

FIG. 7 illustrates an embodiment of the invention with first and second prisms inserted in the light beam;

FIG. 8 illustrates an embodiment of the invention with an alternative second prism;

FIG. 9 illustrates an automated luminaire fitted with an embodiment of the invention;

FIG. 10 illustrates an embodiment of the prism effects system; and;

FIG. 11 illustrates an embodiment of the prism effects system.

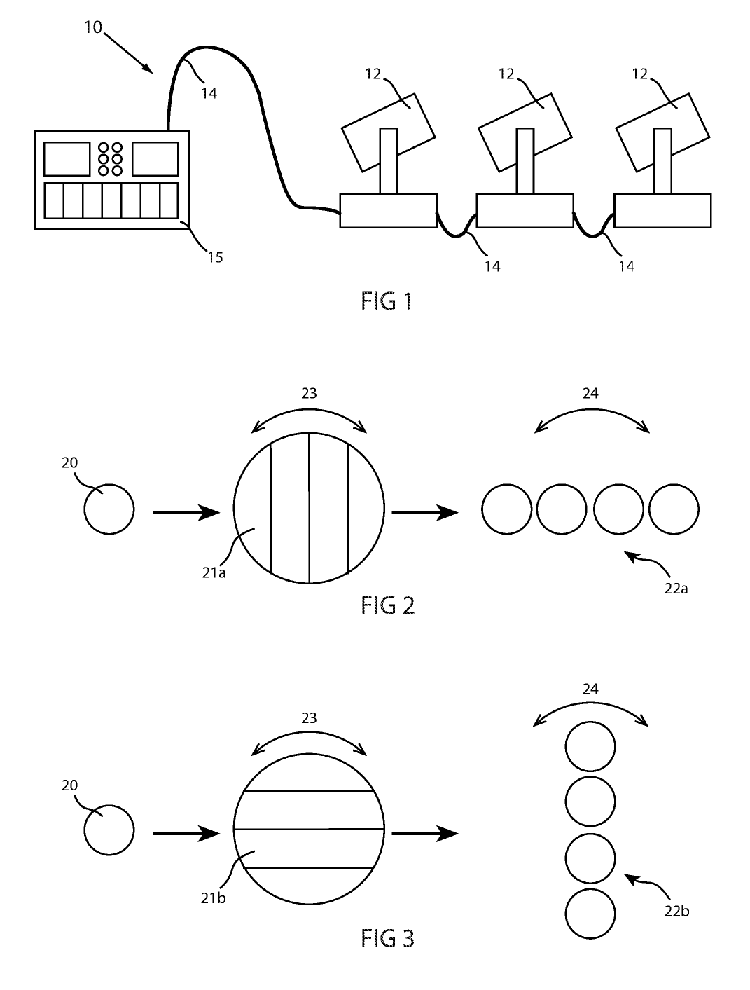

### DETAILED DESCRIPTION OF THE INVENTION

Preferred embodiments of the present invention are illustrated in the FIGS., like numerals being used to refer to like and corresponding parts of the various drawings.

The present invention generally relates to an effects system in a luminaire, and more specifically to a system for coordinating multiple effects within an automated luminaire.

FIG. 4 illustrates an embodiment of the invention in an automated luminaire. Light source 32 produces a light beam whose optical axis is shown by dotted line 36. Light beam 36 may pass through gobo wheel 34 and optical lenses 36 and 37 before being emitted from the luminaire. The system is shown here much simplified for clarity and, in practice, the automated luminaire may include further optical devices including but not restricted to, color wheel, color mixing, rotating gobo, effects wheel, iris, framing shutters and other optical devices well known in the art.

The embodiment shown further includes first prism system 40. First prism system 40 may comprise first prism 42 rotatably contained within first prism arm 41. Motor 44 may be capable of rotating first prism 42 within first prism arm 41. Motor 43 may be capable of inserting or removing first prism arm 41 containing first prism 42 from light beam 36. Motors 43 and 44 may be operated in a coordinated manner such that first prism 42 may be inserted or removed from the light beam and rotated within the light beam as desired by the operator. Motors 43 and 44 may be of a type selected from, but not restricted to, stepper motor, servo-motor, actuator, solenoid, and other motor types well known in the art. In the position shown in FIG. 4 first prism 42 is shown positioned outside of light beam 36 and will have no effect on the exiting light beam.

The embodiment shown further includes second prism system 50. Second prism system 50 may comprise second prism 52 rotatably contained within second prism arm 51. Motor 54 may be capable of rotating second prism 52 within second prism arm 51. Motor 53 may be capable of inserting or removing second prism arm 51 containing second prism 42 from light beam 36. Motors 53 and 54 may be operated in a coordinated manner such that second prism 52 may be inserted or removed from the light beam and rotated within the light beam as desired by the operator. Motors 53 and 54 may be of a type selected from, but not restricted to, stepper motor, servo-motor, actuator, solenoid, and other motor types well known in the art. In the position shown in FIG. 4 second prism 52 is shown positioned outside of light beam 36 and will have no effect on the exiting light beam.

Both first and second prism systems may further contain sensors such that the control system of the automated luminaire is aware of, and in control of, the specific orientation of rotation of first and second prisms. For example, as illustrated in FIG. 4 second prism 52 is fitted with a magnet 57 in its periphery that rotates with second prism 57. A corresponding sensor or sensors (not shown) such as a Hall effect sensor in second prism system 50 may detect the position of magnet 57, and thus deduce the rotational position of second prism 52. Similarly first prism system 40 may be fitted with a magnet and sensor or sensors such that the rotational position of first prism 42 is known and communicated to the control system. The sensor system is not restricted to a magnet and Hall effect sensor, and any sensing system may be utilized in further embodiments of the invention including, but not restricted to, magnetic sensors, optical sensors, switch sensors.

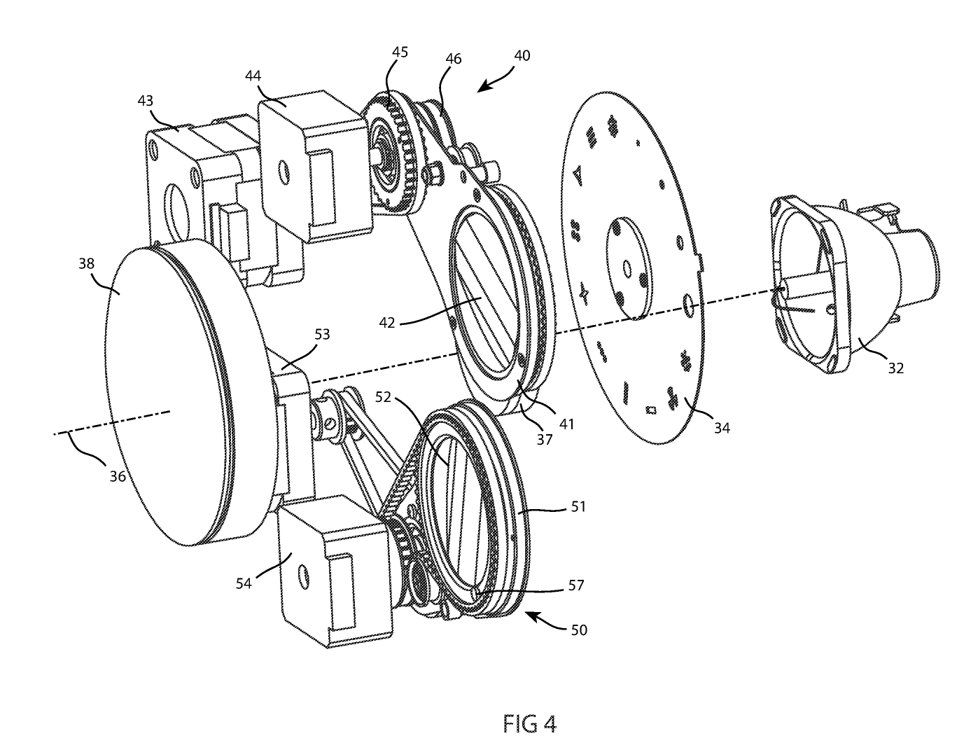

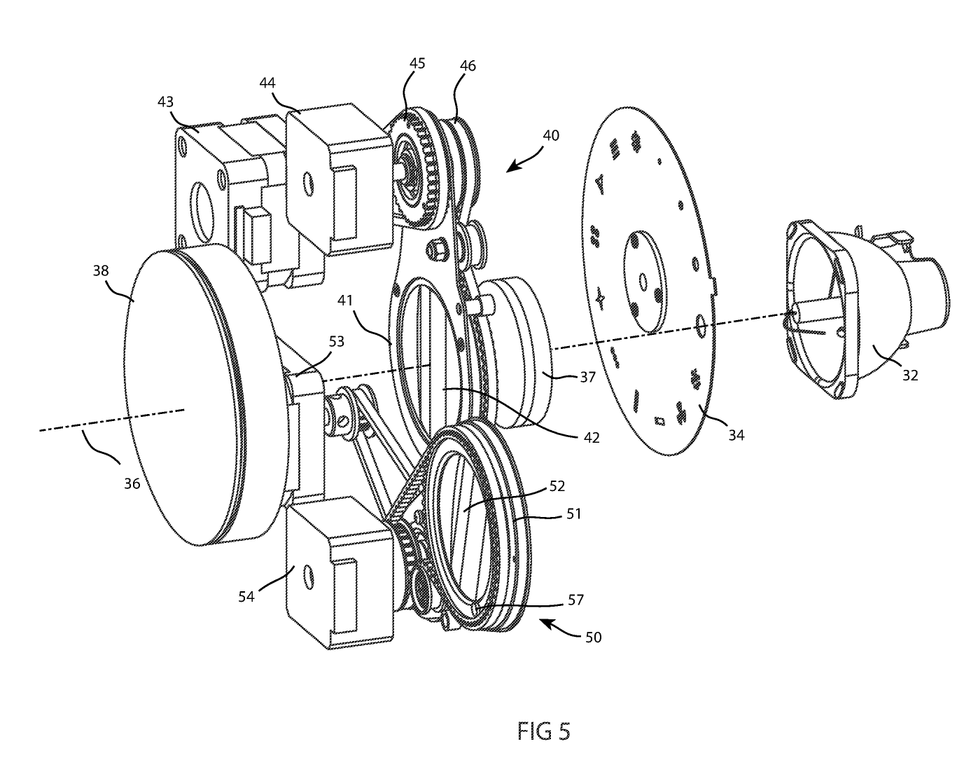

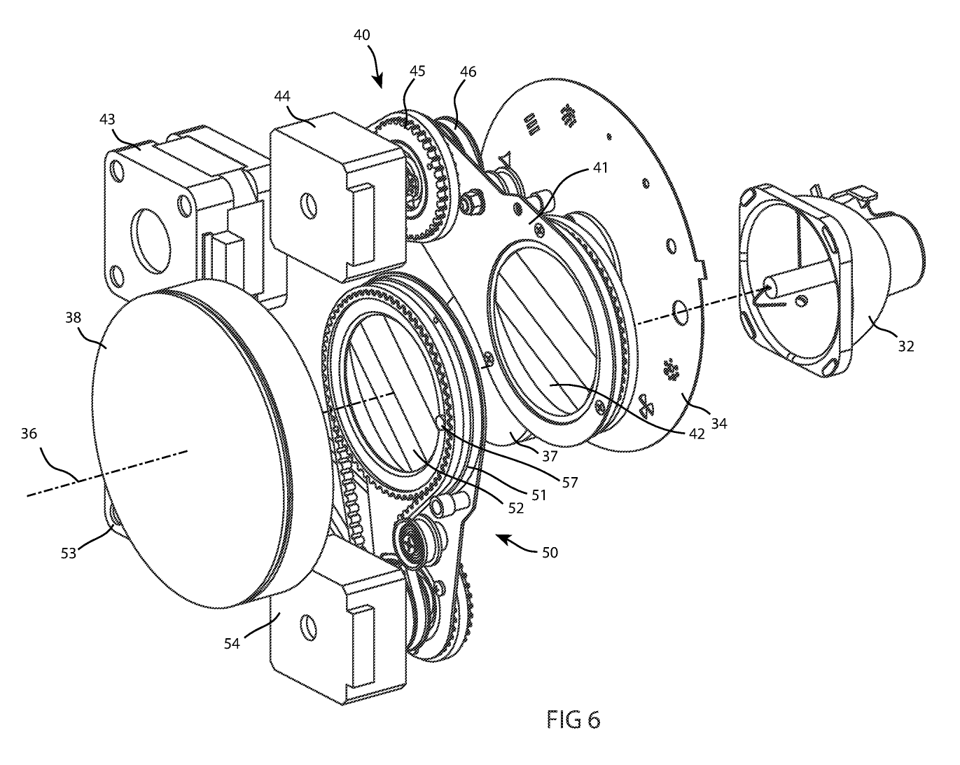

FIG. 5 illustrates an embodiment of the invention in an automated luminaire in a different configuration than shown in FIG. 4. In FIG. 5 motor 43 has been operated so that first prism arm 41 and thus first prism 42 has been inserted across light beam 36. Second prism 52 remains outside light beam 36. In this position first prism 42 alone will produce an effect in the light beam. First prism 42 may be further rotated within the light beam by motor 44 producing effects similar to those illustrated in FIGS. 2 and 3.

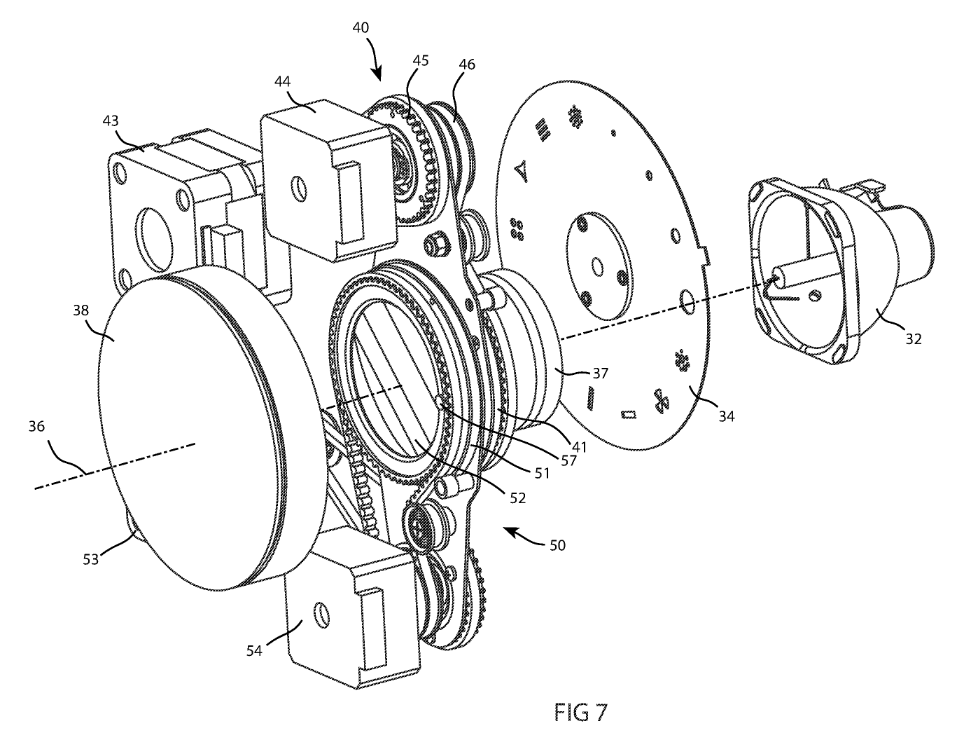

FIG. 6 illustrates an embodiment of the invention in an automated luminaire in a different configuration than shown in FIG. 4. In FIG. 6 motor 53 has been operated so that second prism arm 51 and thus second prism 52 has been inserted across light beam 36. First prism 42 remains outside light beam 36. In this position second prism 52 alone will produce an effect in the light beam. Second prism 52 may be further rotated within the light beam by motor 54 producing effects similar to those illustrated in FIGS. 2 and 3.

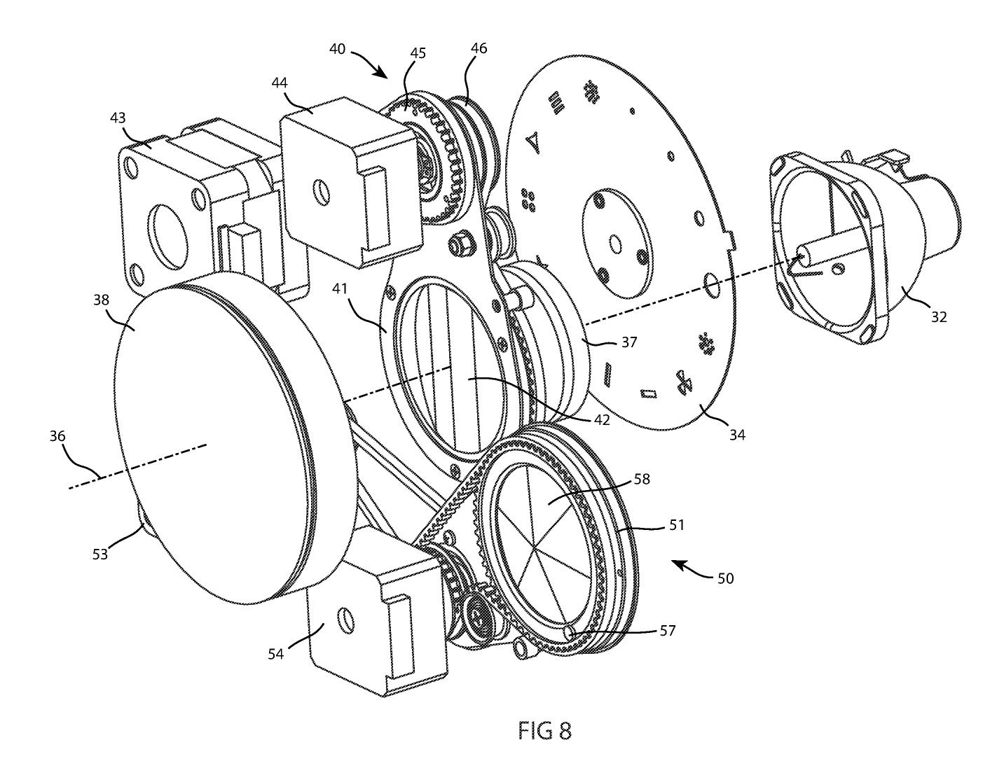

FIG. 7 illustrates an embodiment of the invention in an automated luminaire in a different configuration than shown in FIG. 4. In FIG. 7 motor 43 has been operated so that first prism arm 41 and thus first prism 42 has been inserted across light beam 36. Further, motor 53 has also been operated so that second prism arm 51 and thus second prism 52 has been inserted across light beam 36. In this position both first prism 42 and second prism 52 alone will produce effects in the light beam. First prism 42 and second prism 52 may be further rotated within the light beam by motors 44 and 54. Second prism 52 receives light beam 36 after it has passed through, and been affected by, first prism 42. Thus the effect produced by first prism 42 is then further modified by second prism 52.

FIG. 8 illustrates an embodiment of the invention with a different second prism 58 inserted within second prism arm 51. Similarly first prism 42 may be replaced with alternative prism designs.

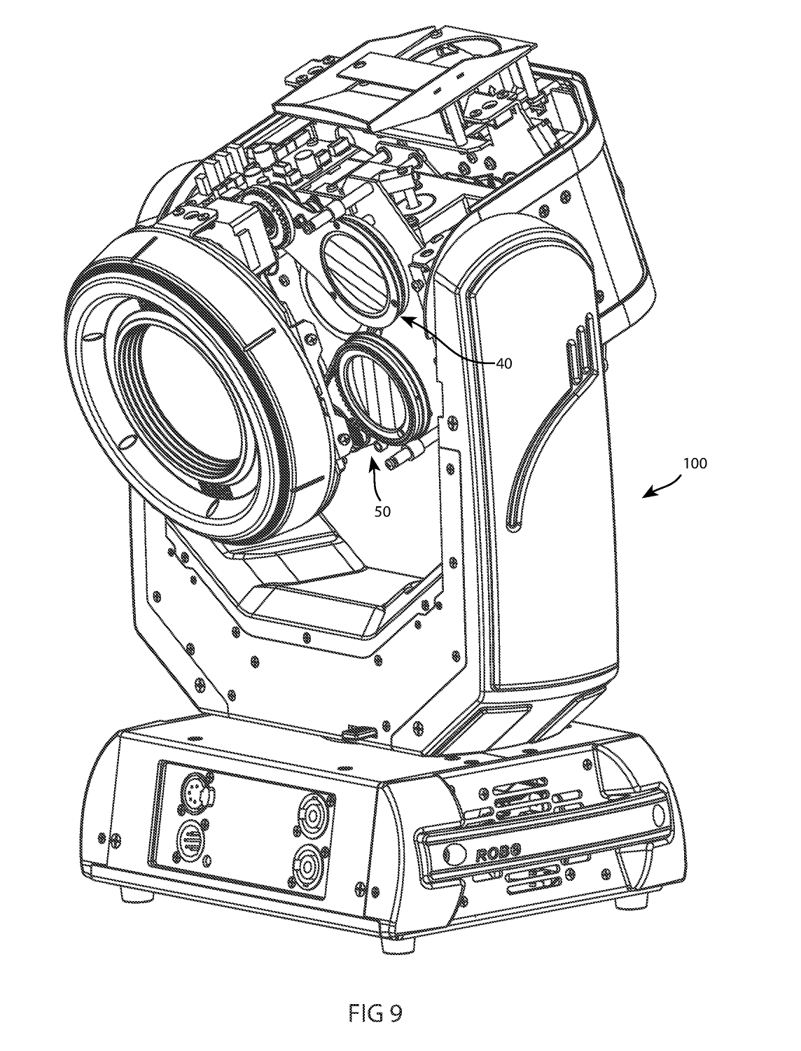

FIG. 9 illustrates an example of automated luminaire 100 fitted with first prism system 40 and second prism system 50.

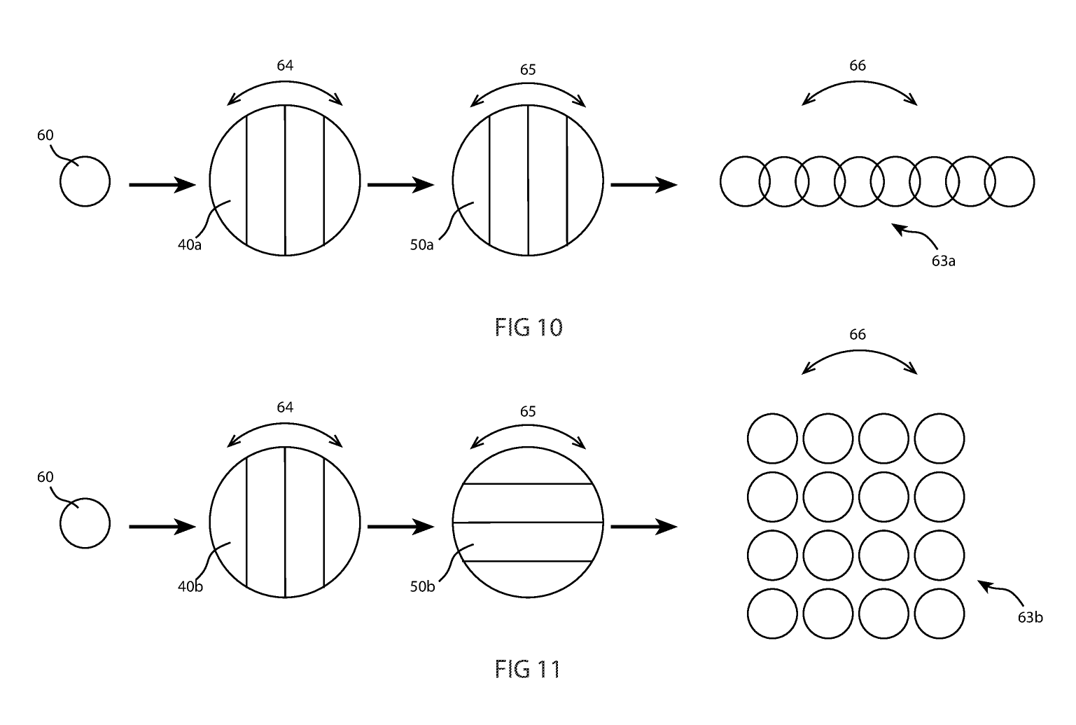

A diagrammatic example of the effects produced by the prism optical system of an embodiment of the invention is shown in FIGS. 10 and 11. In FIG. 10, single image 60 produced by the beam color, size, shape, and pattern optical systems passes through first prism 40a and second prism 50a resulting in multiple copies of image 60 as images 63a. Image 20 is here shown for clarity as a simple circular image, however in reality image 20 may be any complex image as produced by the automated luminaire, in particular it may have a shape defined by the patterns or gobos in the optical train.

Because first prism 40a and second prism 50a are both linear prisms and are aligned in a parallel manner then resultant image array 63a is also linearly aligned. However, both first prism 40a and second prism 50a may be rotated 64 and 65 causing a change in pattern and rotation 66 in the array of output images.

FIG. 11 shows the same optical system and prism, first prism 40b remains in the same position as in FIG. 10, however second prism 50b is rotated 90° to a new position orthogonal to its first position 50a. In this case the linear effect of first prism 40b still forms a single linear array of images, however second prism 50b now acts on that first linear array in an orthogonal direction, resulting in a linear array of a linear array 63b. It can be readily appreciated that intermediate angles between first prism 40b and second prism 50b will produce intermediate effects between those shown in FIG. 10 and FIG. 11.

In a further embodiment first prism 40 and second prism 50 may be simultaneously rotated in a coordinated manner such that the angle between them remains constant. For example, both prisms may be rotated in the same direction at the same speeds thus maintaining the difference in angle between them. The sensors fitted to first and second prisms allow the control system to maintain coordination in the rotation and positioning of the prisms. In a yet further embodiment first and second prisms may be rotated in a coordinated manner at differing speeds and/or differing directions. Speeds and rotation directions and positions may be accurately controlled through sensors such that accurate and repeatable kaleidoscopic effects may be achieved.

Although embodiments with two prism systems have been illustrated and described, the invention is not so limited and any number of prism systems may be utilized to produce complex coordinated effects.

While the invention has been described with respect to a limited number of embodiments, those skilled in the art, having benefit of this invention, will appreciate that other embodiments may be devised which do not depart from the scope of the invention as disclosed herein. Accordingly, the scope of the invention should be limited only by the attached claims.

The invention has been described in detail, it should be understood that various changes, substitutions and alterations can be made hereto without departing from the spirit and scope of the invention as described by the appended claims

We claim:

1. An automated luminare comprising:
a light source generating a light beam;
a first image replicating prism articulated to be either engaged or partially engaged or disengaged with the light beam and articulated to rotate;
a second image replicating prism articulated to be either engaged or partially engaged or disengaged with the light beam and articulated to rotate
where the first image replicating prism and second image replicating prism are articulated so that both or neither can be engaged in the light beam at the same time.

2. The automated luminaire of claim 1 where the prisms replicate the image in a straight line.

3. The automated luminaire of claim 1 where the luminare includes a gobo wheel or image/light-pattern generator.

4. The automated luminaire of claim 3 where the gobos or light patterns generated can be rotated.
